(19) United States
(12) Patent Application Publication
(10) Pub. No.: US 2024/0270923 A1
(43) Pub. Date: Aug. 15, 2024

(54) RECYCLED CONTENT POLYVINYL ALCOHOL

(71) Applicant: Eastman Chemical Company, Kingsport, TN (US)

(72) Inventors: Daryl Bitting, Longview, TX (US); David Eugene Slivensky, Tatum, TX (US); Xianchun Wu, Longview, TX (US)

(73) Assignee: Eastman Chemical Company, Kingsport, TN (US)

(21) Appl. No.: 18/567,249

(22) PCT Filed: Jun. 1, 2022
(86) PCT No.: PCT/US2022/031710

§ 371 Date: Dec. 5, 2023

Related U.S. Application Data
(60) Provisional application No. 63/202,446, filed on Jun. 11, 2021.

(51) Int. Cl. C08J 11/10; C08F 18/08

(52) U.S. Cl. CPC C08J 11/10; C08F 18/08; C08J 2300/30

(57) ABSTRACT

Recycled content polyvinyl alcohol (r-PVOH) is produced using a process and system that applies physical and/or credit-based recycled content from one or more feed materials to the PVOH produced from the feed materials.

### BACKGROUND

Polyvinyl alcohol is an important chemical used in a wide variety of applications. For example, polyvinyl alcohol is used as a thickening agent or protective colloid in high viscosity solutions where low solid content is desired. Polyvinyl alcohol is also used in paper and textile sizing applications, and as an intermediate in the production of polymers such as polyvinyl butyral, which is used as an adhesive interlayer when forming laminated safety glass.

The demand for recycled chemical products continues to grow, but there is no clear path to recycled polyvinyl alcohol through mechanical recycling. Thus, there exists a need for a commercial process to produce recycled content polyvinyl alcohol.

### SUMMARY

In one aspect, the present technology concerns a process for producing polyvinyl alcohol having recycled content (r-PVOH), the process comprising: (a) synthesizing vinyl acetate by reacting a first ethylene and a first acetic acid/anhydride with oxygen; (b) polymerizing at least a portion of the vinyl acetate to thereby produce a polyvinyl acetate; (c) reacting at least a portion of the polyvinyl acetate with a first alcohol to thereby produce a polyvinyl alcohol (PVOH), wherein the PVOH comprises recycled content from one or more of the following source materials—(i) a waste plastic, (ii) a recycled content ethylene (r-ethylene), (iii) a recycled content alcohol (r-alcohol), and/or (iv) a recycled content acetic acid/anhydride (r-acetic acid/anhydride).

In one aspect, the present technology concerns a process for producing a polyvinyl acetal having recycled content, the process comprising: (a) reacting a first ethylene and a first acetic acid/anhydride with a first oxygen to thereby produce a vinyl acetate; (b) polymerizing at least a portion of the vinyl acetate to thereby produce a polyvinyl acetate; (c) subjecting at least a portion of the polyvinyl acetate to alcoholysis with ethanol to thereby produce a polyvinyl alcohol; and (d) acetalizing at least a portion of the polyvinyl alcohol with a first aldehyde to thereby produce a polyvinyl acetal, wherein the polyvinyl acetal comprises recycled content from one or more of the following source materials—(i) a waste plastic, (ii) a recycled content syngas (r-syngas), (iii) a recycled content ethylene (r-ethylene), (iv) a recycled content carbon monoxide, and (v) a recycled content acetic acid/anhydride (r-acetic acid/anhydride).

### BRIEF DESCRIPTION OF THE DRAWINGS

FIG. 1 is a block flow diagram illustrating the main steps of a process and facility for making recycled content polyvinyl alcohol (r-PVOH) and, optionally, a recycled content polyvinyl acetal (r-PVAc), where the r-PVOH (and r-PVAc) has physical recycled content from one or more source materials;

FIG. 2 is a block flow diagram illustrating the main steps of a process and facility for making recycled content polyvinyl alcohol (r-PVOH) and, optionally, a recycled content polyvinyl acetal (r-PVAc), where the r-PVOH (and r-PVAc) has credit-based recycled content from one or more source materials; and

FIG. 3 is a block flow diagram illustrating the main steps of a process and facility for making recycled content polyvinyl alcohol (r-PVOH) and, optionally, a recycled content polyvinyl acetal (r-PVAc), where the r-PVOH (and r-PVAc) has both physical and credit-based recycled content from one or more source materials.

### DETAILED DESCRIPTION

We have discovered new methods and systems for producing polyvinyl alcohol (PVOH) and, optionally, polyvinyl acetals having recycled content. More specifically, we have discovered a process and system for producing PVOH where recycled content from waste materials, such as waste plastic, are applied to PVOH in a manner that promotes the recycling of waste plastic and provides PVOH with substantial amounts of recycled content.

In general, PVOH can be formed by reacting ethylene and acetic acid/anhydride in the presence of oxygen via oxidative addition to form vinyl acetate. At least a portion of the vinyl acetate may then be polymerized to form polyvinyl acetate, which can then be hydrolyzed with an alcohol (usually methanol or ethanol) to produce polyvinyl alcohol. In some embodiments, the polyvinyl alcohol can then be condensed with an aldehyde to form a polyvinyl acetal. The PVOH can include recycled content from one or more source materials, including, for example, waste plastic, recycled content ethylene (r-ethylene), recycled content carbon monoxide (r-CO), recycled content acetic acid/anhydride (r-acetic acid/anhydride), and recycled content alcohol (r-alcohol). When the PVOH is reacted with an aldehyde to form a polyvinyl acetal (PVAc), the PVAc can include recycled content from one or more source material including, for example, waste plastic, r-ethylene, r-acetic acid/anhydride, r-CO, r-alcohol (r-methanol or r-ethanol), and r-syngas. The recycled content in the PVOH (and, when produced, the PVAc) can be physical and may directly originate from at least one of these streams, and/or the recycled content may be credit-based and applied to a target stream in the PVOH (or PVAc) process from one or more of these source streams.

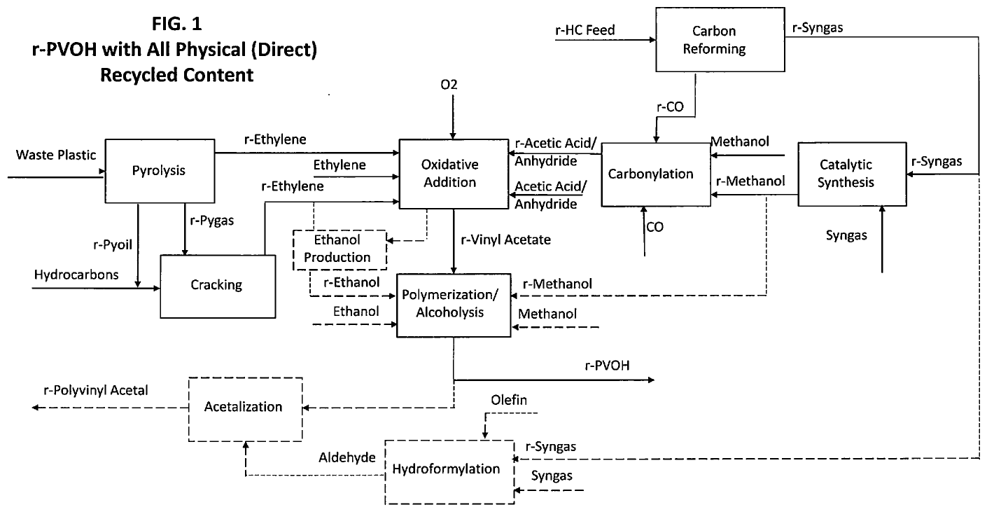

Turning now to FIG. 1, one embodiment of a process and facility for forming PVOH with physical (direct) recycled content is provided. The recycled content in the PVOH can originate from the pyrolysis and cracking of waste plastic and/or from carbon reforming of a recycled content hydrocarbon-containing feed (r-HC). The resulting PVOH can have a total recycled content of at least 5, at least 10, at least 25, at least 50, or at least 65 percent and/or less than 99, less than 95, less than 90, or less than 85 percent.

As shown in FIG. 1, waste plastic can be pyrolyzed to form recycled content pyrolysis gas (r-pygas) and recycled content pyrolysis oil (r-pyoil). All or a part of the r-pygas and/or r-pyoil can be introduced into a cracking facility, where it can be used to produce a recycled content olefin, such as recycled content ethylene (r-ethylene). The feed to the cracking facility can include only r-pyoil and/or r-pygas, or it can also include a non-recycled content hydrocarbon, such as naphtha (e.g., C5 to C22) or lighter hydrocarbon components (e.g., C2 to C5).

As shown in FIG. 1, all or a portion of the recycled content ethylene from the cracking and/or pyrolysis can be used in the oxidative addition reaction with acetic acid/anhydride and oxygen to form recycled content vinyl acetate (r-vinyl acetate). In one embodiment, at least a portion of the feed to the oxidative addition can include non-recycled content ethylene. In some embodiments, the ethylene used in the addition reaction can include at least 50, at least 75, at least 90, or 100 percent recycled content.

In some embodiments, the PVOH production facility may also include carbon reforming of a recycled content hydrocarbon-containing feed stream (r-HC) to produce a recycled content syngas (r-syngas) and a recycled content carbon monoxide (r-CO) having physical recycled content. In one embodiment, the feed to carbon reforming can comprise both a recycled content feed component (e.g., waste plastic) and a non-recycled content feed component (e.g., coal, a liquid hydrocarbon, and/or a gaseous hydrocarbon). In one embodiment, the carbon reforming is partial oxidation gasification that is fed with coal and waste plastic. In another embodiment, the carbon reforming is plasma gasification of a predominately waste plastic feed. In yet another embodiment, the carbon reforming is partial oxidation gasification fed with a non-recycled content liquid or gaseous hydrocarbon and a recycled content pyrolysis oil produced from the pyrolysis of waste plastic. In some embodiments, the carbon reforming can include catalytic reforming, while in other embodiments, the carbon reforming can include steam reforming.

In some embodiments, at least a portion of the r-syngas from the carbon reforming can be reacted in the presence of a catalyst to form recycled content methanol (r-methanol). The r-methanol can then be subjected to carbonylation to form recycled content acetic acid/anhydride (r-acetic acid/anhydride). All or a portion of the acetic acid/anhydride used to produce the r-vinyl acetate may be r-acetic acid/anhydride formed from r-syngas (and/or r-methanol). In some embodiments, at least a portion of the syngas, methanol, and/or acetic acid/anhydride may be non-recycled content material. In some embodiments, the syngas, methanol, and/or acetic acid can include at least 50, at least 75, at least 90, or 100 percent recycled content, individually.

As shown in FIG. 1, the r-vinyl acetate formed in the PVOH production facility can then be polymerized to form recycled content polyvinyl acetate (r-polyvinyl acetate), which can be further reacted with an alcohol (e.g., ethanol or methanol) to form recycled content polyvinyl alcohol (r-polyvinyl alcohol). In one embodiment, at least a portion of the alcohol can include a recycled content alcohol. For example, when ethanol is used during the alcoholysis reaction, all or a portion of the ethanol can be formed by hydrolysis of recycled content ethylene (r-ethylene), which may originate from the cracking and/or pyrolysis shown in FIG. 1. Other suitable processes for producing r-ethanol can also be used, including hydrogenation of acetaldehyde. In some cases, at least a portion of the acetaldehyde (a byproduct of the vinyl acetate production reaction) from within the PVOH facility can be used to form the r-ethanol. Similarly, when methanol is used for alcoholysis of the r-polyvinyl acetate, all or a portion of the methanol can originate from the catalytic synthesis of r-syngas as described previously.

After alcoholysis, the resulting stream of r-PVOH can have a recycled content of at least 5, at least 10, at least 15, at least 20, at least 25, at least 30, at least 35, at least 40, at least 45, at least 50, at least 55, or at least 65 percent and/or 100 percent, or less than 99, less than 95, less than 90, less than 85, less than 80, less than 75, or less than 70 percent.

The amount of physical recycled content in the r-PVOH can determined by tracing the amount of recycled material along a chemical pathway starting with waste plastic and ending with the PVOH. The chemical pathway includes all chemical reactions and other processing steps (e.g., separations) between the starting material (e.g., waste plastic) and the PVOH. In FIG. 1, the chemical pathway includes pyrolysis, cracking, carbon reforming, catalytic synthesis, carbonylation, oxidative addition, polymerization, and alcoholysis.

In one or more embodiments, a conversion factor can be associated with each step along the chemical pathway. The conversion factors account for the amount of the recycled content diverted or lost at each step along the chemical pathway. For example, the conversion factors can account for the conversion, yield, and/or selectivity of the chemical reactions along the chemical pathway.

The amount of recycled content applied to the r-PVOH can be determined using one of variety of methods for quantifying, tracking, and allocating recycled content among various materials in various processes. One suitable method, known as “mass balance,” quantifies, tracks, and allocates recycled content based on the mass of the recycled content in the process. In certain embodiments, the method of quantifying, tracking, and allocating recycled content is overseen by a certification entity that confirms the accuracy of the method and provides certification for the application of recycled content to the r-PVOH.

In some embodiments, shown as being optional in FIGS. 1-3, all or a portion of the r-PVOH can be further condensed (e.g., acetalized) with an aldehyde to form a recycled content polyvinyl acetal (r-PVAc). The aldehyde may be a C2 to C24, C3 to C10, or a C4 to C6 aldehyde, or it can comprise, for example, butyraldehyde. In some embodiments, the aldehyde can include recycled content (from, for example, hydroformylation of an olefin with recycled content syngas, as shown in FIG. 1), or it may include non-recycled content aldehyde. Although not shown in FIG. 1, all or a portion of the olefin may also have recycled content and may, in some cases, originate from the pyrolysis and cracking of syngas (e.g., recycled content propylene). When the aldehyde used is a C4 aldehyde, the resulting polyvinyl acetal can comprise polyvinyl butyral.

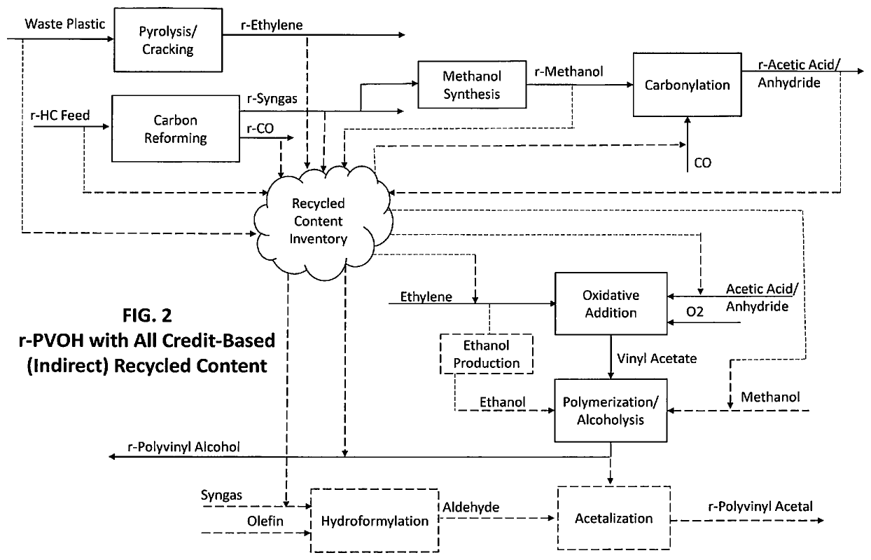

Turning now to FIG. 2, an embodiment where the r-PVOH has no physical recycled content, but has credit-based recycled content, is provided. In the process and system depicted in FIG. 2, the r-acetic acid/anhydride and r-ethylene are not directly fed to the vinyl acetate synthesis reaction, nor is the r-methanol used in alcoholysis. Additionally, the r-ethylene is not directly used to make r-ethanol for alcoholysis, nor is the r-CO directly used in forming the acetic acid/anhydride.

Instead, recycled content credits from the recycled content streams shown in FIG. 2 (e.g., the r-ethylene, the r-methanol, the r-acetic acid/anhydride, the r-CO and, when used, the r-syngas) can be attributed to one or more streams in the production facility. For example, the recycled content credits from one or more of the above streams can be attributed to the ethylene and/or acetic acid/anhydride fed to the vinyl acetate synthesis step, the ethanol or methanol fed to the alcoholysis step, and/or the syngas fed to the hydroformylation step (when performed). As such, the r-ethylene, the r-methanol, the r-acetic acid/anhydride, the r-CO and, when used, the r-syngas each act as a “source material” of recycled content credits and the ethylene and/or acetic acid/anhydride fed to the vinyl acetate synthesis step, the ethanol or methanol fed to the alcoholysis step, and/or the syngas fed to the hydroformylation step (when performed) each act as a “target material” to which the recycled content credits are attributed.

In one or more embodiments, the source material has physical recycled content and the target material has less than 100 percent physical recycled content. For example, the source material can have at least 10, at least 25, at least 50, at least 75, at least 90, at least 99, or 100 percent physical recycled content and/or the target material can have less than 100, less than 99, less than 90, less than 75, less than 50, less than 25, less than 10, or less than 1 percent physical recycled content.

The ability to attribute recycled content credits from a source material to a target material removes the co-location requirement for the facility making the source material (with physical recycled content) and the facility making the PVOH (or polyvinyl acetal). This allows a chemical recycling facility/site in one location to process waste material into one or more recycled content source materials and then apply recycled content credits from those source materials to one or more target materials being processed in existing commercial facilities located remotely from the chemical recycling facility/site. Further, the use of recycled content credits allows different entities to produce the source material and the r-PVOH. This allows efficient use of existing commercial assets to produce r-PVOH. In one or more embodiments, the source material is made at a facility/site that is at least 0.1, at least 0.5, at least 1, at least 5, at least 10, at least 50, at least 100, at least 500, or at least 1000 miles from the facility/site where the target material is used to make PVOH.

The attributing of recycled content credits from the source material (e.g., the r-ethylene produced from pyrolysis/cracking of waste plastic) to the target material (e.g., the ethylene fed to the vinyl acetate synthesis step) can be accomplished by transferring recycled content credits directly from the source material to the target material. Alternatively, as shown in FIG. 2, recycled content credits can be applied from any of the waste plastic, the recycled content hydrocarbon feed to the carbon reforming step (r-HC), the r-syngas, the r-CO, the r-methanol, the r-ethylene, and/or the r-acetic acid/anhydride to the PVOH (or polyvinyl acetal) via a recycled content inventory. The recycled content inventory can be a digital inventory or database used to record and track recycled content for various materials at various sites over various time periods.

When a recycled content inventory is used, recycled content credits from the source material having physical recycled content (e.g., the waste plastic, the r-HC, the r-ethylene, the r-syngas, the r-CO, the r-methanol, and/or the r-acetic acid/anhydride in FIG. 2) are booked into the recycled content inventory. The recycled content inventory can also contain recycled content credits from other sources and from other time periods. In one embodiment, recycled content credits in the recycled content inventory can only be assigned to target materials having the same or similar composition as the source materials. For example, as shown in FIG. 2, recycled content credits booked into the recycled content inventory from the r-ethylene from pyrolysis/cracking can be assigned to the ethylene fed to the synthesis because the two ethylene streams have the same or similar compositions. However, recycled content credits from r-ethylene could not be assigned to the methanol fed to the alcoholysis because the source and target materials would not be the same or similar.

In some embodiments, all or a portion of the recycled content credit can be applied to one or more target materials (e.g., syngas) upon receipt of one or more waste plastic containing materials at the facility. That is, the waste plastic (or recycled content hydrocarbon feed) need not be processed before applying the credit-based recycled content to the target material. Instead, receipt of the waste plastic (or waste-plastic containing material) at the facility can permit application of recycled content credit to one or more target materials. In most cases, however, such waste plastic will then be processed at the facility within 30, 60, or 90 days to produce one or more of the target materials. Once recycled content credits have been attributed to the target material (e.g., the ethylene and/or acetic acid/anhydride fed to the catalytic synthesis and/or the methanol or ethanol fed during alcoholysis in FIG. 2), the amount of the credit-based recycled content allocated to the PVOH is calculated by tracing the recycled content along the chemical pathway from the target material to the PVOH. The chemical pathway includes all chemical reactions and other processing steps (e.g., separations) between the target material and the PVOH, and a conversion factor can be associated with each step along the chemical pathway of the credit-based recycled content. The conversion factors account for the amount of the recycled content diverted or lost at each step along the chemical pathway. For example, the conversion factors can account for the conversion, yield, and/or selectivity of the chemical reactions along the chemical pathway.

As with the physical recycled content, the amount of credit-based recycled content applied to the r-PVOH can be determined using one of variety of methods, such as mass balance, for quantifying, tracking, and allocating recycled content among various materials in various processes. In certain embodiments the method of quantifying, tracking, and allocating recycled content is overseen by a certification entity that confirms the accuracy of the method and provides certification for the application of recycled content to the r-PVOH.

The r-PVOH produced by the process of FIG. 4 can have 25 to 90, 40 to 80, or 55 to 65 percent credit-based recycled content and less than 50, less than 25, less than 10, less than 5, or less than 1 percent physical recycled content. In certain embodiments, the PVOH can have 10 to 80, 20 to 75, or 25 to 70 percent credit-based recycled content from one or more of the r-syngas, the r-CO, the r-methanol, the r-ethylene, and the r-acetic acid/anhydride, individually.

In one or more embodiments, the recycled content of the r-PVOH product can include both physical recycled content and credit-based recycled content. For example, the r-PVOH can have at least 10, at least 20, at least 30, at least 40, or at least 50 percent physical recycled content and at least 10, at least 20, at least 30, at least 40, or at least 50 percent credit-based recycled content. As used herein, the term “total recycled content” refers to the cumulative amount of physical recycled content and credit-based recycled content from all sources.

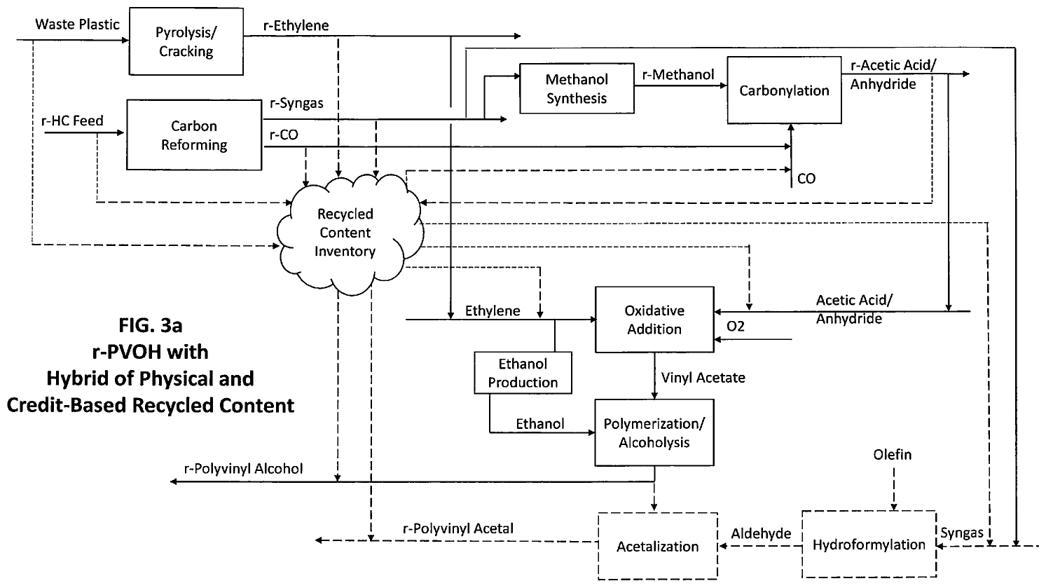

FIG. 3 illustrates several embodiments of an r-PVOH production process and system, wherein physical recycled content and credit-based recycled content are attributed to the r-PVOH. Any combination of physical (solid lines) and credit-based (dashed lines) recycled content shown in FIG. 3 can be used to form and/or can be attributed to PVOH to thereby produce r-PVOH. For example, physical recycled content can be supplied by at least 1, at least 2, at least 3, at least 4, at least 5, or all of the sources shown in FIG. 3, including the r-ethylene, the r-CO, the r-acetic acid/anhydride, the r-methanol, and, when used, the r-syngas, while the credit-based recycled content can be supplied by one or more of the other sources shown in FIG. 3. In some embodiments, the r-PVOH can include 10 to 60, 20 to 50, or 25 to 40 percent physical recycled content and 10 to 60, 20 to 50, or 25 to 40 percent credit-based recycled content. Alternatively, the r-PVOH can include less than 15, less than 10, or less than 5 percent physical recycled content (or credit-based recycled content) and at least 85, at least 90, or at least 95 percent credit based recycled content (or physical recycled content).

For example, in some embodiments, physical recycled content can be provided by r-ethylene fed to catalytic synthesis, while credit-based recycled content can be provided by acetic acid/anhydride fed to the same process. In other embodiments, the physical recycled content can be provided by the acetic acid/anhydride, while the ethylene can provide credit-based recycled content. Alternatively, both the acetic acid/anhydride and ethylene can be the source of physical recycled content, or both can provide credit-based recycled content.

Similarly, when ethanol is used in the alcoholysis, it can provide physical and/or credit-based recycled content from the ethylene. In some cases, the ethylene used to form the r-ethanol can be formed from pyrolysis of waste plastic. Similarly, when methanol is used in the alcoholysis, it can provide physical and/or credit-based recycled content, typically from the syngas. In some cases, the syngas used to form the r-methanol can be formed from the carbon reforming of a recycled content hydrocarbon containing feed.

Turning again to the embodiment shown in FIG. 1, the carbon reforming facility and/or the pyrolysis/cracking facility can be co-located with the r-PVOH production facility. In the embodiment shown in FIG. 2, the carbon reforming facility and/or the pyrolysis cracking facility can be remotely located from the r-PVOH production facility. In the embodiment shown in FIG. 3, the portions of the pyrolysis/cracking facility providing physical recycled content to the r-PVOH facility may be co-located, while the portions of the pyrolysis/cracking facility providing credit-based recycled content to the r-PVOH facility may be remotely located. When remotely located, the two facilities can be at least 0.5, 1, 5, 10, 100, 500, 1000, or 10,000 miles from the other. When co-located, the two facilities can be within 5, 1, 0.5, or 0.25 miles of one another. When acetalization is performed, one or more of the above are also true for the PVAc facility, with regard to the pyrolysis/cracking facility, carbon reforming facility, and PVOH facility. As discussed previously, when remotely located, two or more of the facilities may be owned and/or operated by the same or by different commercial entities.

The recycled content PVOH can be used in a variety of end use applications. For example, the r-PVOH can be used as a sizing agent for textile or paper applications or it can be included with one or more polymers in an adhesive formulation. It can also be used as an emulsifier and/or a component of a coating or it can be further processed/reacted to form a recycled content polymer (such as, for example, a polyvinyl acetal as discussed herein).

### Claim Supporting Description—First Embodiment

In a first embodiment of the present technology there is provided a process for producing polyvinyl alcohol having recycled content (r-PVOH), the process comprising: (a) synthesizing vinyl acetate by reacting a first ethylene and a first acetic acid/anhydride with oxygen; (b) polymerizing at least a portion of the vinyl acetate to thereby produce a polyvinyl acetate; (c) reacting at least a portion of the polyvinyl acetate with a first alcohol to thereby produce a polyvinyl alcohol (PVOH), wherein the PVOH comprises recycled content from one or more of the following source materials—(i) a waste plastic, (ii) a recycled content ethylene (r-ethylene), (iii) a recycled content alcohol (r-alcohol), and/or (iv) a recycled content acetic acid/anhydride (r-acetic acid/anhydride).

The first embodiment described in the preceding paragraph can also include one or more of the additional aspects listed below. The each of the following additional aspects of the first embodiment can be standalone features or can be combined with one or more of the other additional aspects to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein the r-alcohol comprises methanol.
   wherein the r-methanol is formed from a recycled content syngas (r-syngas).
      wherein at least a portion of the r-syngas is formed from carbon reforming of a recycled content hydrocarbon feed stream.
wherein the r-alcohol comprises ethanol.
   wherein the r-ethanol is formed from a recycled content ethylene (r-ethylene).
      wherein at least a portion of the r-ethylene is formed from pyrolysis of waste plastic.
wherein the PVOH comprises physical and credit-based recycled content from one or more of the source materials.
wherein the PVOH comprises physical recycled content from the r-ethylene and/or the r-acetic acid/anhydride.
wherein the PVOH comprises credit-based recycled content from the r-alcohol and/or the r-CO.
wherein at least a portion of the r-ethylene is made from a waste plastic and wherein the first ethylene comprises at least a portion of the r-ethylene.
further comprising reacting at least a portion of the r-ethylene to form recycled content ethanol (r-ethanol) and wherein said first alcohol comprises at least a portion of said r-ethanol.
further comprising carbon reforming a recycled content hydrocarbon-containing feedstock to thereby produce an r-syngas stream (r-syngas) and subjecting at least a portion of the r-syngas to methanol synthesis to form a recycled content methanol (r-methanol), wherein said first alcohol comprises at least a portion of the r-methanol.
wherein the carbon reforming comprises partial oxidation gasification of the hydrocarbon-containing feedstock and wherein the first acetic acid/anhydride is formed from at least a portion of the r-syngas.
wherein at least a portion of the first acetic acid/anhydride is produced by converting a second syngas into a first methanol and then subjecting at least a portion of the methanol to carbonylation with carbon monoxide to thereby produce acetic acid/anhydride, wherein the second syngas comprises at least a portion of the r-syngas from the carbon reforming and/or wherein the carbon monoxide comprises a recycled content carbon monoxide (r-CO) produced during the making of the r-syngas.
wherein the synthesizing, polymerizing, and reacting are carried out in an PVOH production facility, wherein at least one of the source materials providing recycled content to the PVOH is produced in a remote source facility that is located at least 100 miles from the PVOH production facility, and wherein the PVOH comprises credit-based recycled content from the at least one source material produced in the remote source facility.
wherein the synthesizing, polymerizing, and reacting are carried out in an PVOH production facility, wherein at least one of the source materials is produced in a co-located source facility located within 5 miles of the PVOH production facility, and wherein the PVOH comprises physical recycled content from the at least one source material produced in the co-located source facility.
further comprising acetalizing at least a portion of the recycled PVOH with at least one aldehyde to form a recycled content polyvinyl acetal.
wherein the aldehyde is a C3 to C6 aldehyde.
further comprising applying credit-based recycled content to the PVOH from the one or more source materials.
wherein the applying includes (i) attributing recycled content from at least one of the source materials having physical recycled content to at least one target material via recycled content credits, (ii) tracing recycled content along at least one chemical pathway from the at least one target material to the PVOH, and (iii) allocating recycled content to the PVOH based at least in part on the tracing of recycled content along the chemical pathway.
wherein at least one of the following criterial is met (i) the source material and the target material both comprise ethylene, (ii) the source material and the target material both comprise acetic acid/anhydride, (iii) the source material and the target material both comprise methanol, and/or (iv) the source material and the target material both comprise carbon monoxide.
wherein the attributing includes (i) booking recycled content credits attributable to the at least one source material into a digital inventory and (ii) assigning recycled content credits from the digital inventory to the target material, and wherein the tracing includes determining one or more conversion factors for one or more chemical reactions along the chemical pathway, wherein the attributing includes assigning credit-based recycled content from a digital inventory to the target material, wherein the conversion factors determine how much of the credit-based recycled content applied to the target material is allocated to the PVOH.
further comprising synthesizing methanol from a syngas stream comprising recycled content syngas (r-syngas) to form recycled content methanol (r-methanol) and subjecting at least a portion of the r-methanol to carbonylation to form a recycled content acetic acid/anhydride (r-acetic acid/anhydride), wherein the first acetic acid/anhydride used in the synthesis of vinyl acetate includes r-acetic acid/anhydride.
further comprising, hydroformylating a first propylene with a first syngas to form a recycled content n-butyraldehyde (r-n-butyraldehyde), wherein at least one of the first propylene and the first syngas comprise recycled content propylene (r-propylene) or recycled content syngas (r-syngas), and wherein the first n-butyraldehyde comprises at least a portion of the r-n-butyraldehyde.
   wherein the first propylene comprises r-propylene.
      wherein the r-propylene is formed from the pyrolysis of waste plastic.
   wherein the first syngas comprises r-syngas.
      wherein the r-syngas is formed from carbon reforming of recycled content hydrocarbon feed comprising waste plastic.
wherein the PVOH comprises physical recycled content from one or more of the source materials.
wherein the PVOH comprises credit-based recycled content from one or more of the source materials.
wherein the PVOH comprises physical and credit-based recycled content from one or more of the source materials.
wherein the PVOH comprises recycled content from the r-ethylene.
   wherein the PVOH comprises physical recycled content from the r-ethylene.
   wherein the PVOH comprises credit-based recycled content from the r-ethylene.
wherein the PVOH comprises recycled content from the r-CO.
   wherein the PVOH comprises physical recycled content from the r-CO.
   wherein the PVOH comprises credit-based recycled content from the r-CO.
wherein the PVOH comprises recycled content from the r-methanol.
   wherein the PVOH comprises physical recycled content from the r-methanol.
   wherein the PVOH comprises credit-based recycled content from the r-methanol.
wherein the PVOH comprises recycled content from the r-acetic acid/anhydride.
   wherein the PVOH comprises physical recycled content from the r-acetic acid/anhydride.
   wherein the PVOH comprises credit-based recycled content from the r-acetic acid/anhydride.
wherein the synthesis, polymerizing, and reacting are carried out in an PVOH production facility, wherein at least one the source materials providing recycled content to the PVOH is produced in a remote source facility that is located at least 0.5, 1, 5, 10, 100, 500, 1000 or 10,000 miles from the PVOH production facility.
   wherein the PVOH comprises credit-based recycled content from the at least one source material produced in the remote source facility.
wherein the reacting, polymerizing, hydrolyzing, and acetalizing are carried out in an PVOH production facility, wherein at least one of the source materials is produced in a co-located source facility located within 5, 1, 0.5, or 0.25 miles of the PVOH production facility.
   wherein the PVOH comprises physical recycled content from the at least on source material produced in the remote source facility.
further comprising making r-syngas from at least one recycled content hydrocarbon-containing feedstock.
   wherein the making comprises partial oxidation gasification and/or steam reforming of the hydrocarbon-containing feedstock.
   wherein at least one of the following criteria is met—
      (i) the first alcohol comprises methanol formed from at least a portion of the r-syngas, and/or
      (ii) the first acetic acid/anhydride is formed from at least a portion of the r-syngas.
   wherein at least a portion of the first acetic acid/anhydride is produced by converting a second syngas into a methanol and then subjecting at least a portion of the methanol to carbonylation to thereby produce acetic acid/anhydride.
      wherein the second syngas comprises at least a portion of the r-syngas formed from said recycled content hydrocarbon containing feedstock.
wherein at least a portion of the r-ethylene is made from a waste plastic.
   wherein at least a portion of the r-ethylene is made by pyrolyzing and/or cracking the waste plastic.
   wherein the first ethylene comprises at least a portion of the r-ethylene.
further comprising apply credit-based recycled content to the PVOH from the one or more source materials.
   wherein the applying includes (i) attributing recycled content from at least one of the source materials having physical recycled content to at least one target material via recycled content credits, (ii) tracing recycled content along at least one chemical pathway from the at least one target material to the PVOH, and (iii) allocating recycled content to the PVOH based at least in part on the tracing of recycled content along the chemical pathway.
      wherein at least one of the following criterial is met (i) the source material and the target material both comprise ethylene, (ii) the source material and the target material both comprise acetic acid/anhydride, (iii) the source material and the target material both comprise carbon monoxide, and/or (iv) the source material and the target material both comprise methanol.
         wherein the at least one target material comprise one or more of the first acetic acid/anhydride, the first ethylene, and/or the first alcohol.
      wherein at least one of the following criteria (i)-(iv) is met:
      (i) the source material comprises the r-syngas having physical recycled content,
      (ii) the source material comprises the r-acetic acid/anhydride having physical recycled content and the target material comprises the first acetic acid/anhydride,
      (iii) the source material comprises the r-CO having physical recycled content, and/or
      (iv) the source material comprises the r-ethylene having physical recycled content and the target material comprises the first ethylene.
      wherein the attributing includes (i) booking recycled content credits attributable to the at least one source material into a digital inventory and (ii) assigning recycled content credits from the digital inventory to the target material.
         wherein the tracing includes determining one or more conversion factors for one or more chemical reactions along the chemical pathway, wherein the attributing includes assigning credit-based recycled content from a digital inventory to the target material, wherein the conversion factors determine how much of the credit-based recycled content applied to the target material is allocated to the PVOH.
wherein the process further comprises a step of obtaining certification from a certification entity for the applying of the credit based recycled content.
wherein the recycled content of the source material is from waste plastic.
wherein the source material and the target material have substantially the same physical composition.
wherein at least 50, 75, 90, 95, 99, or 100 weight percent of the source material is identical to the target material.
wherein the r-PVOH has a total recycled content of at least 10, 20, 30, 40, 50, 75, 90, 95, or 100 percent.
wherein the r-PVOH has at least 10, 20, 30, 40, 50 percent physical recycled content and at least 10, 20, 30, 40, or 50 percent credit-based recycled content.
wherein the source material has physical recycled content and the target material has less than 100 percent physical recycled content.
wherein the source material has at least 10, 25, 50, 75, 90, or 99 percent physical recycled content.
wherein the target material has less than 99, 90, 75, 50, 25, 10, or 1 percent physical recycled content.
wherein the source material has 100 percent physical recycled content and the target material has no physical recycled content.
wherein none of the first ethylene, the first acetic acid/anhydride, or the first alcohol have physical recycled content.
wherein at least one (at least two, at least three, all) of the first ethylene, the first acetic acid/anhydride, and the first alcohol have physical recycled content.
wherein the applying further comprises applying physical recycled content to at least a portion of the PVOH so that the r-PVOH has both physical recycled content and credit-based recycled content.
wherein the physical recycled content applied to the PVOH is from at least one of the r-ethylene, r-acetic acid/anhydride, and r-methanol or r-ethanol.
wherein the target material comprises the ethylene and at least a portion of the credit-based recycled content allocated to the PVOH is traced through a first chemical pathway from the ethylene to the PVOH.
wherein the target material comprises the acetic acid/anhydride and at least a portion of the credit-based recycled content allocated to the PVOH is traced through a second chemical pathway from the acetic acid/anhydride to the PVOH.
wherein the target material comprises the alcohol and at least a portion of the credit-based recycled content allocated to the PVOH is traced through a third chemical pathway from the alcohol to the PVOH.

### Claim Supporting Description—Second Embodiment

In a second embodiment of the present technology there is provided a process for producing a polyvinyl acetal having recycled content, the process comprising: (a) reacting a first ethylene and a first acetic acid/anhydride with a oxygen to thereby produce a vinyl acetate; (b) polymerizing at least a portion of the vinyl acetate to thereby produce a polyvinyl acetate; (c) subjecting at least a portion of the polyvinyl acetate to alcoholysis with a first ethanol to thereby produce a polyvinyl alcohol; and (d) acetalizing at least a portion of the polyvinyl alcohol with a first aldehyde to thereby produce a polyvinyl acetal, wherein the polyvinyl acetal comprises recycled content from one or more of the following source materials—(i) a waste plastic, (ii) a recycled content syngas (r-syngas), (iii) a recycled content ethylene (r-ethylene), (iv) a recycled content carbon monoxide, and (v) a recycled content acetic acid/anhydride (r-acetic acid/anhydride).

The second embodiment described in the preceding paragraph can also include one or more of the additional aspects listed below. The each of the following additional aspects of the second embodiment can be standalone features or can be combined with one or more of the other additional aspects to the extent consistent.
further comprising acetalizing at least a portion of the PVOH with n-butyraldehyde to thereby produce polyvinyl butyral (PVB), wherein the PVB comprises recycled content from one or more of the source materials (i) through (iv).
further comprising hydroformylating an olefin with a first syngas to provide the first aldehyde, wherein said first syngas comprises at least a portion of the r-syngas so that the aldehyde is a recycled content aldehyde (r-aldehyde).
   wherein the olefin comprises propylene.
      wherein at least a portion of the propylene is recycled content propylene formed from the pyrolysis of waste plastic.
wherein the reacting, polymerizing, alcohol, and acetalizing are carried out in a polyvinyl acetal (PVAc) production facility, wherein at least one of the source materials providing recycled content to the PVAc is produced in a remote source facility that is located at least 5 miles from the PVAc production facility, and wherein the PVAc comprises credit-based recycled content from the at least one source material produced in the remote source facility.
further comprising applying credit-based recycled content to the PVAc from the one or more source materials, wherein the applying includes (i) attributing recycled content from at least one of the source materials having physical recycled content to at least one target material via recycled content credits, (ii) tracing recycled content along at least one chemical pathway from the at least one target material to the PVAc, and (iii) allocating recycled content to the PVAc based at least in part on the tracing of recycled content along the chemical pathway, and wherein at least one of the following criterial is met (i) the source material and the target material both comprise syngas, (ii) the source material and the target material both comprise acetic acid/anhydride, (iii) the source material and the target material both comprise methanol, (iv) the source material and the target material both comprise carbon monoxide, and/or (v) the source material and the target material both comprise ethylene.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical pathway” refers to the chemical processing step or steps (e.g., chemical reactions, physical separations, etc.) between an input material and a product material, where the input material is used to make the product material.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and CO) that are useful by themselves and/or are useful as feedstocks to another chemical production process(es).

As used herein, the term “co-located” refers to the characteristic of at least two objects being situated on a common physical site, and/or within 5, 1, 0.5, or 0.25 miles of each other.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “credit-based recycled content,” “non-physical recycled content,” and “indirect recycled content” all refer to matter that is not physically traceable back to a waste material, but to which a recycled content credit has been attributed.

As used herein, the term “directly derived” refers to having at least one physical component originating from waste material.

As used herein, the terms “including,” “include,” and “included” have the same open-ended meaning as “comprising,” “comprises,” and “comprise” provided above.

As used herein, the term “indirectly derived” refers to having an applied recycled content (i) that is attributable to waste material, but (ii) that is not based on having a physical component originating from waste material.

As used herein, the term “located remotely” refers to a distance of at least 0.1, 0.5, 1, 5, 10, 50, 100, 500, or 1000 miles between two facilities, sites, or reactors.

As used herein, the term “mass balance” refers to a method of tracking recycled content based on the mass of the recycled content in various materials.

As used herein, the terms “physical recycled content” and “direct recycled content” both refer to matter that is physically traceable back to a waste material.

As used herein, the term “predominantly” means more than 50 percent by weight. For example, a predominantly propane stream, composition, feedstock, or product is a stream, composition, feedstock, or product that contains more than 50 weight percent propane.

As used herein, the term “recycled content” refers to being or comprising a composition that is directly and/or indirectly derived from recycle material. Recycled content is used generically to refer to both physical recycled content and credit-based recycled content. Recycled content is also used as an adjective to describe material having physical recycled content and/or credit-based recycled content.

As used herein, the term “recycled content credit” refers to a non-physical measure of physical recycled content that can be directly or indirectly (i.e., via a digital inventory) attributed from a first material having physical recycled content to a second material having less than 100 percent physical recycled content.

As used herein, the term “total recycled content” refers to the cumulative amount of physical recycled content and credit-based recycled content from all sources.

As used herein, the term “waste material” refers to used, scrap, and/or discarded material.

As used herein, the terms “waste plastic” and “plastic waste” refer to used, scrap, and/or discarded plastic materials.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process for producing polyvinyl alcohol having recycled content (r-PVOH), the process comprising:
(a) synthesizing vinyl acetate by reacting a first ethylene and a first acetic acid/anhydride with oxygen;
(b) polymerizing at least a portion of the vinyl acetate to thereby produce a polyvinyl acetate;
(c) reacting at least a portion of the polyvinyl acetate with a first alcohol to thereby produce a polyvinyl alcohol (PVOH),
wherein the PVOH comprises recycled content from one or more of the following source materials—(i) a waste plastic, (ii) a recycled content ethylene (r-ethylene), (iii) a recycled content alcohol (r-alcohol), and/or (iv) a recycled content acetic acid/anhydride (r-acetic acid/anhydride).

2. The process of claim 1, wherein the PVOH comprises physical and credit-based recycled content from one or more of the source materials.

3. The process of claim 1 or 2, wherein the PVOH comprises physical recycled content from the r-ethylene and/or the r-acetic acid/anhydride.

4. The process of claim 2, wherein the PVOH comprises credit-based recycled content from the r-alcohol and/or the r-CO.

5. The process of claim 1, wherein at least a portion of the r-ethylene is made from a waste plastic and wherein the first ethylene comprises at least a portion of the r-ethylene.

6. The process of claim 5, further comprising reacting at least a portion of the r-ethylene to form recycled content ethanol (r-ethanol) and wherein said first alcohol comprises at least a portion of said r-ethanol.

7. The process of claim 1, further comprising carbon reforming a recycled content hydrocarbon-containing feedstock to thereby produce an r-syngas stream (r-syngas) and subjecting at least a portion of the r-syngas to methanol synthesis to form a recycled content methanol (r-methanol), wherein said first alcohol comprises at least a portion of the r-methanol.

8. The process of claim 7, wherein the carbon reforming comprises partial oxidation gasification of the hydrocarbon-containing feedstock and wherein the first acetic acid/anhydride is formed from at least a portion of the r-syngas.

9. The process of claim 8, wherein at least a portion of the first acetic acid/anhydride is produced by converting a second syngas into a first methanol and then subjecting at least a portion of the methanol to carbonylation with carbon monoxide to thereby produce acetic acid/anhydride, wherein the second syngas comprises at least a portion of the r-syngas from the carbon reforming and/or wherein the carbon monoxide comprises a recycled content carbon monoxide (r-CO) produced during the making of the r-syngas.

10. The process of claim 1, wherein the synthesizing, polymerizing, and reacting are carried out in an PVOH production facility, wherein at least one of the source materials providing recycled content to the PVOH is produced in a remote source facility that is located at least 100 miles from the PVOH production facility, and wherein the PVOH comprises credit-based recycled content from the at least one source material produced in the remote source facility.

11. The process of claim 1, wherein the synthesizing, polymerizing, and reacting are carried out in an PVOH production facility, wherein at least one of the source materials is produced in a co-located source facility located within 5 miles of the PVOH production facility, and wherein the PVOH comprises physical recycled content from the at least one source material produced in the co-located source facility.

12. The process of claim 1, further comprising acetalizing at least a portion of the recycled PVOH with at least one aldehyde to form a recycled content polyvinyl acetal.

13. The process of claim 12, wherein the aldehyde is a C3 to C6 aldehyde.

14. The process of claim 1, further comprising applying credit-based recycled content to the PVOH from the one or more source materials.

15. The process of claim 14, wherein the applying includes (i) attributing recycled content from at least one of the source materials having physical recycled content to at least one target material via recycled content credits, (ii) tracing recycled content along at least one chemical pathway from the at least one target material to the PVOH, and (iii) allocating recycled content to the PVOH based at least in part on the tracing of recycled content along the chemical pathway.

16. The process of claim 15, wherein at least one of the following criterial is met (i) the source material and the target material both comprise ethylene, (ii) the source material and the target material both comprise acetic acid/anhydride, (iii) the source material and the target material both comprise methanol, and/or (iv) the source material and the target material both comprise carbon monoxide.

17. The process of claim 15, wherein the attributing includes (i) booking recycled content credits attributable to the at least one source material into a digital inventory and (ii) assigning recycled content credits from the digital inventory to the target material, and wherein the tracing includes determining one or more conversion factors for one or more chemical reactions along the chemical pathway, wherein the attributing includes assigning credit-based recycled content from a digital inventory to the target material, wherein the conversion factors determine how much of the credit-based recycled content applied to the target material is allocated to the PVOH.

18. A process for producing a polyvinyl acetal having recycled content (r-PVAc), the process comprising:
(a) reacting a first ethylene and a first acetic acid/anhydride with oxygen to thereby produce a vinyl acetate;
(b) polymerizing at least a portion of the vinyl acetate to thereby produce a polyvinyl acetate;
(c) subjecting at least a portion of the polyvinyl acetate to alcoholysis with a first ethanol to thereby produce a polyvinyl alcohol; and
(d) acetalizing at least a portion of the polyvinyl alcohol with a first aldehyde to thereby produce a polyvinyl acetal,
wherein the polyvinyl acetal comprises recycled content from one or more of the following source materials—(i) a waste plastic, (ii) a recycled content syngas (r-syngas), (iii) a recycled content ethylene (r-ethylene), (iv) a recycled content carbon monoxide, and (v) a recycled content acetic acid/anhydride (r-acetic acid/anhydride).

19. The process of claim 18, further comprising hydroformylating an olefin with a first syngas to provide the first aldehyde, wherein said first syngas comprises at least a portion of the r-syngas so that the aldehyde is a recycled content aldehyde (r-aldehyde).

20. The process of claim 18, further comprising applying credit-based recycled content to the polyvinyl acetal from the one or more source materials, wherein the applying includes (i) attributing recycled content from at least one of the source materials having physical recycled content to at least one target material via recycled content credits, (ii) tracing recycled content along at least one chemical pathway from the at least one target material to the polyvinyl acetal, and (iii) allocating recycled content to the polyvinyl acetal based at least in part on the tracing of recycled content along the chemical pathway, and wherein at least one of the following criterial is met (i) the source material and the target material both comprise ethylene, (ii) the source material and the target material both comprise acetic acid/anhydride, (iii) the source material and the target material both comprise syngas, and/or (iv) the source material and the target material both comprise carbon monoxide.
